(19) United States
(12) Patent Application Publication
(10) Pub. No.: US 2008/0035586 A1
(43) Pub. Date: Feb. 14, 2008

(54) Enhanced coalescer

(75) Inventors: James C.T. Chen, Houston, TX (US); Shaya Movafaghian, Houston, TX (US)

Correspondence Address: CAMERON INTERNATIONAL CORPORATION, P.O. BOX 1212, HOUSTON, TX, 77251-1212, US

(73) Assignee: Petreco International Inc.

(21) Appl. No.: 11/501,448

(22) Filed: Aug. 9, 2006

(51) Int. Cl. C02F 1/38

(52) U.S. Cl. 210/788; 210/804; 210/259; 210/512.1; 210/DIG. 5

(57) ABSTRACT

A coalescer is used in series with a hydrocyclone to enhance the removal of a dispersed phase from a continuous phase by first using a coalescer that lacks removal of any separated dispersed phase prior to cyclonic action in the hydrocyclone. The coalescer has no oil outlet and serves to coalesce the droplets or particles of the disperse phase together thereby increasing contaminant size distribution. The second hydrocyclone functions as a separator operating at higher removal efficiency. The method and apparatus are useful to clarify produced water from hydrocarbon recovery operations.

### BACKGROUND OF THE INVENTION

The present invention relates to methods and apparatus for separating a liquid/liquid continuous mixture, and more particularly relates, in one embodiment, to methods and apparatus for separating or dividing a liquid dispersed phase from a liquid continuous phase of a fluid mixture.

The overall construction and manner of operation of hydrocyclones is well known. A typical hydrocyclone includes an elongated body surrounding a tapered separation chamber of circular cross-section, the separation chamber decreasing in cross-sectional size from a large overflow and input end to a narrow underflow end. An overflow or reject outlet for the lighter fraction is provided at the wider end of the conical chamber while the heavier underflow or accept fraction of the suspension exits through an axially arranged underflow outlet at the opposite end of the conical chamber. (It will be appreciated that the terms “reject” and “accept” are relative and depend upon the nature and value of the lighter and the heavier fractions.) Liquids and suspended particles are introduced into the chamber via one or more tangentially directed inlets, which inlets create a fluid vortex in the separation chamber. The centrifugal forces created by this vortex throw denser fluids and particles in suspension outwardly toward the wall of the conical separation chamber, thus giving a concentration of denser fluids and particles adjacent thereto, while the less dense fluids are brought toward the center of the chamber and are carried along by an inwardly-located helical stream created by differential forces. The lighter fractions are thus carried outwardly through the overflow outlet. The heavier particles and/or fluids continue to spiral along the interior wall of the hydrocyclone and exit the hydrocyclone via the underflow outlet.

The fluid velocities within a hydrocyclone are high enough that the dynamic forces produced therein are sufficiently high to overcome the effect of any gravitational forces on the performance of the device. The performance of hydrocyclones is thus relatively insensitive to their physical orientation. Hydrocyclones, especially those for petroleum fluid processing, are commonly arranged in large banks of several dozen or even several hundred hydrocydones with suitable intake, overflow and underflow assemblies arranged for communication with the intake, overflow and underflow openings, respectively, of the hydrocyclones.

Hydrocyclones are used both for the separation of liquids from solids in a liquid/solid mixture (“liquid/solid hydrocyclones”) as well as for the separation of liquids from other liquids (“liquid/liquid hydrocyclones”). Different constructions are used for each of these hydrocyclone devices. Generally, the liquid/liquid type of hydrocyclone is longer in the axial direction than a solid/liquid hydrocyclone and is thinner as well. As a result of these structural differences, it cannot be assumed that the design and structure of a liquid/liquid hydrocyclone usefully translates to a liquid/solid hydrocyclone and vice versa.

In the recovery of hydrocarbons from subterranean formations, it is common that the fluids produced are mixtures of aqueous fluids, typically water, and non-aqueous fluids, typically crude oil and/or other hydrocarbons. These fluid mixtures are often in the form of tight emulsions that are difficult to separate. In general, oil-in-water emulsions (o/w) and water-in-oil emulsions (w/o) are separated by physical processes, chemical processes, such as through the use of demulsifiers and other additives, or combinations of the two. Hydrocyclones are known to be a useful physical method of separating oil phase fluids from aqueous phase fluids, along with other apparatus including, but not necessarily limited to, coalescers, settling tanks, centrifuges, membranes, and the like. Further, electrostatic separators employ electrical fields and the differences in surface conductivity of the materials to be separated to aid in these separations.

“Produced water” is the term used to refer to streams generated by the recovery of hydrocarbons from subterranean formations that are primarily water, but may contain significant amounts of non-aqueous contaminants dispersed therein. Typically, produced water results from an initial separation of oil and water, and accounts for a majority of the waste derived from the production of crude oil. After a primary process of separation from the oil, the produced water still contains drops or particles of oil in emulsion in concentrations as high as 2000 mg/l, and thus it must be further treated before it may be properly discharged to the environment. Every country has set limits for the concentration of oil dispersed in the water for offshore wells and for near-shore fields. Even if the produced water is returned to the field, it is advisable to remove as much of the oil and suspended solids (e.g., sand, rock fragments, and the like) as possible in order to minimize the risk of clogging the field.

Shown in FIG. 1 is one conventional, prior art separation system or apparatus 10 having a conventional coalescer 20 and a hydrocyclone 30 down-stream therefrom. Coalescer 20 is a vessel having a first inlet portion 22 and a first outlet portion 24 and at least some coalescing media 26 therebetween that will be described in more detail below. Produced water 12 enters coalescer 20 through first inlet portion 22 where the oil particles therein are at least partially coalesced at media 26. Coalescer 20 also has an oil overflow outlet port 28 through which oil 14 egresses. Water containing some remaining oil 16 exits coalescer 20 through a line, pipe, tube or conduit to hydrocyclone 30. Hydrocyclone 30 has a second inlet portion 32 and a second overflow outlet portion 34 and a third underflow outlet portion 36. Hydrocydone 30 operates conventionally to separate less dense and remaining oil 18 through second outlet portion 34 and the water 40 via third outlet portion 36.

It would be desirable if methods and apparatus were devised that could simultaneously remove oil and other non-aqueous species from produced water and contaminated water with greater efficiency than at present.

### BRIEF SUMMARY OF THE INVENTION

In carrying out these and other objects of the invention, there is provided, in one non-restrictive form, an exemplary apparatus for separating a dispersed liquid phase from a continuous liquid phase within a fluid mixture. The apparatus includes a vessel (e.g. a coalescer) having a first inlet portion and a first outlet portion and has coalescing media intermediate the first inlet portion and the first outlet portion. The first outlet portion of the vessel is configured to effuse substantially all fluid flow received at the first inlet portion and egressing from the vessel. The apparatus further includes an elongate hollow member (e.g. a hydrocyclone) having a second inlet portion and a second outlet portion. The second inlet portion has a greater cross-section diameter, taken transverse to a longitudinal axis of the second elongate member as compared with the second outlet portion thereof. The elongate hollow member further has a third outlet portion. In the apparatus the first outlet portion is in fluid communication with the second inlet portion. Further, the second inlet portion of the elongate hollow member is upstream of the second and third outlet portions.

As another example and in another non-limiting embodiment, a method is provided for separating a dispersed liquid phase from a continuous liquid phase within a fluid mixture. The method involves routing a flow of the fluid mixture into a first inlet portion of a vessel, at least partially coalescing the dispersed liquid phase by contacting it with coalescing media within the vessel, and egressing the flow of the fluid mixture only from a first outlet portion of the vessel. The method further includes routing the flow of the fluid mixture from the first outlet portion of the vessel to a second inlet portion of an elongate hollow member. The method also involves discharging a relatively less dense, coalesced liquid phase of the flow of fluid through a second outlet portion of the elongate hollow member and located toward one side of the second inlet portion of the elongate hollow member. The method further concerns discharging a relatively more dense liquid phase of the flow of fluid through a third outlet portion of the elongate hollow member and located on an opposite side from the second inlet portion of the elongate hollow member and the second outlet portion of the elongate hollow member.

In another non-restrictive example, there is provided an apparatus for separating a dispersed liquid phase from a continuous liquid phase within a fluid mixture. The apparatus involves at least one coalescer that includes a first separation chamber having a first inlet, coalescing media downstream of the first inlet, and at least one outlet downstream of the coalescing media for discharging therefrom the fluid mixture that includes an at least partially coalesced dispersed liquid phase. The invention further includes at least one separator hydrocyclone that concerns at least one second inlet for introducing the fluid mixture comprising the at least partially coalesced dispersed liquid phase into the hydrocyclone. The hydrocyclone also contains at least one overflow outlet for discharging therefrom a relatively less dense, coalesced liquid phase of the fluid mixture, and at least one underflow outlet on the other end of the hydrocyclone from the at least one overflow outlet for discharging a relatively more dense liquid phase of the fluid mixture. The apparatus further includes at least one fluid communication between the at least one outlet of the at least one coalescer and the at least one second inlet of the at least one separator hydrocyclone.

In still another non-limiting embodiment a method for separating a dispersed liquid phase from a continuous liquid phase within a fluid mixture. The method concerns introducing the fluid mixture into at least one coalescer and contacting the fluid mixture within the coalescer with coalescing media to at least partially coalesce the dispersed liquid phase. A fluid mixture comprising an at least partially coalesced dispersed liquid phase is discharged to at least one separator hydrocyclone. The fluid mixture is swirled within the separator hydrocyclone to substantially separate the at least partially coalesced dispersed liquid phase. A relatively less dense, coalesced liquid phase of the fluid mixture is discharged through an overflow outlet of the separator hydrocyclone, and a relatively more dense liquid phase of the fluid mixture discharged through an underflow outlet of the separator hydrocyclone.

### BRIEF DESCRIPTION OF THE SEVERAL VIEWS OF THE DRAWING

FIG. 1 is a schematic cross-sectional illustration of a prior art embodiment of an apparatus showing a coalescer discharging separated oil and discharging a mixture of water and oil into a hydrocyclone; and

FIG. 2 is a schematic, cross-sectional illustration of one non-restrictive embodiment of an apparatus including a coalescer having no oil overflow port, and discharging a mixture of water and at least partially coalesced oil into a hydrocyclone for further separation.

It will be appreciated that the Figures are schematic illustrations that are not to scale or proportion, and, as such, some of the important parts of the invention may be exaggerated for illustration.

### DETAILED DESCRIPTION OF THE INVENTION

Non-limiting exemplary methods and apparatus described herein enhance the removal of a dispersed phase from a continuous phase intermixed therewith by means of the coalescing action of coalescing media in a vessel and the cyclonic action of at least one hydrocyclone in series therewith. The first vessel, also known as a coalescer herein, increases the size of the dispersed phase, while subsequently a separator hydrocyclone or batch of separator hydrocyclones separates the coalesced dispersed phase from the continuous phase at a higher removal efficiency. In one non-limiting embodiment, the dispersed phase may be a contaminant, such as oil in a continuous phase of produced water. A non-limiting application for the apparatus and methods herein is to separate the components of a wellbore fluid involved in hydrocarbon recovery, including, but not necessarily limited to, produced water from a subterranean formation. In a nonrestrictive instance, produced water on an offshore platform that has the contaminants sufficiently removed therefrom may be properly disposed of in the sea.

In more detail, one non-restrictive example includes utilization of this method to enhance removal efficiency of a produced water treatment, where existing hydrocyclones or degassers or flotation units do not meet oil and grease discharge requirements due to small size distribution of the contaminants. Indeed, hydrocyclone performance is a function of particle size. The larger the oil droplets' size, the better the oil removal efficiency becomes. The methods and apparatus herein will increase the oil droplet size by coalescing the smaller oil droplets into larger droplets in the coalescing vessel in order to enhance the performance of the downstream hydrocyclone.

Although conventional coalescers generally have an oil overflow outlet or port, it will be appreciated that the coalescer herein in an exemplary apparatus described herein does not have a conventional oil overflow port or outlet. In one sense, the method and apparatus herein “plugs” or eliminates the oil outlet from the first vessel and allows the coalesced oil droplets to flow through the vessel. In this process, the effluent from the coalescing vessel will contain much larger oil droplets so as to enhance the performance of the downstream hydrocyclone.

Thus, the coalescer vessel together with the downstream hydrocyclone are being used to remove the oil in the produced water. Due to the tighter regulations of lower permitted oil concentrations in the produced water for disposal, the effluent from the hydrocyclone must be polished by down stream equipment such as flotation, etc. However, it is expected that the methods and apparatus herein may permit the coalescer and the hydrocyclone combination only to be able to meet the required effluent standards in many cases.

Each coalescer or group of coalescers, or each hydrocyclone or batch of hydrocyclones may be contained within a single enclosure or vessel or may be housed within separate enclosures or vessels. For instance, in one non-limiting embodiment, the coalescer(s) may be housed or contained in one vessel while the separator hydrocyclone(s) may be contained or housed in a second vessel. In general, in another optional, alternative embodiment, the separator hydrocyclones have a conical section or profile followed by a tubular tail section which may or may not be tapered on the inside.

The first unit, vessel or coalescer contains at least some coalescing media therein to coalesce smaller dispersed droplets or particles into larger ones in the continuous phase. Some well-known and widely used systems employ corrugated plate interceptors and parallel plate interceptors, but these tend to be limited to oil emulsions where particle sizes are 30 μm or larger. The removal of oil emulsions where the diameter of the particles is less than 20 μm is very difficult with these devices because in many cases these smaller particles make up a high proportion of the total oil content, and it is difficult or impossible to reduce the level in the discharge to the permissible levels with conventional equipment.

Several media materials are used alone or together. Commonly used media include, but are not necessarily limited to, polymeric materials, sand, anthracite, and clay have also been used as separation and/or filtration media. When sand, anthracite and clay are used they are produced with a particular form or shape. These filtration technologies are generally limited however because of their sensitivity to the presence of viscous oils and/or suspended solids. It is not unusual that the materials used as a separation media become clogged with highly viscous oils or with suspended solids within 24 hours of operation, thus requiring replacement of the filtration media or backwashing with fresh or treated water, which results in even more oily wastes or more contaminated backwash liquids.

The coalescing media may, in particular, be an absorbent or adsorbent material. Absorbent or adsorbent materials which have relatively low absorption or adsorbent ability or capacity, such that coalesced droplets are readily released from the material are especially advantageous herein. In one non-limiting embodiment, the bulk of the mixture or dispersion is allowed to flow directly through the absorbent material, with the bulk of the dispersion flowing through an extensive network of passages between the filaments or strands and through the pores in the filaments or strands themselves. The absorbent may in one non-restrictive version have a limited capacity to temporarily trap the dispersed oil droplets due to its affinity for them but then also permits or allows the relatively larger, coalesced droplets to be released.

Due to this ability, the absorbent may thus also be an effective coalescing media. When an oily dispersion of fine droplets is passed through the coalescing media, some of the oil droplets will be temporarily retained, trapped or held within or on the pores of the absorbent due to their attraction for the absorbent. Here the non-aqueous droplets will be held until others find their way into the pores, and as more enter or accumulate they will eventually produce droplets that are sufficiently close to one another to contact and coalesce. This process will continue until the pores are relatively full and the larger droplets will be forced out by the flow of the liquid and because of their size to start rising. The relatively uniform nature of the absorbent filaments, strands and pores makes for the release of a substantially uniform size droplet.

In another non-limiting embodiment, the coalescing media used in the methods and apparatus herein has a high surface area and/or a substantially homogeneous porous mass, which may in one non-restrictive version be a polymeric matrix such as polyester, polystyrene, polypropylene, polyethylene, polyurethane, and mixtures thereof, which has the ability to absorb/adsorb fine oil emulsions within or on its relatively uniform and fibrous network structure. The physical separation phenomenon on the polymeric matrix that produces the coalescence of the oil droplets and the separation of the aqueous and non-aqueous phases on the polymer, may be a complex phenomenon and is likely to be a combination of absorption and adsorption followed by the coalescence of the small non-aqueous phase droplets into larger droplets, although the inventors herein do not wish to be limited to any particular theory.

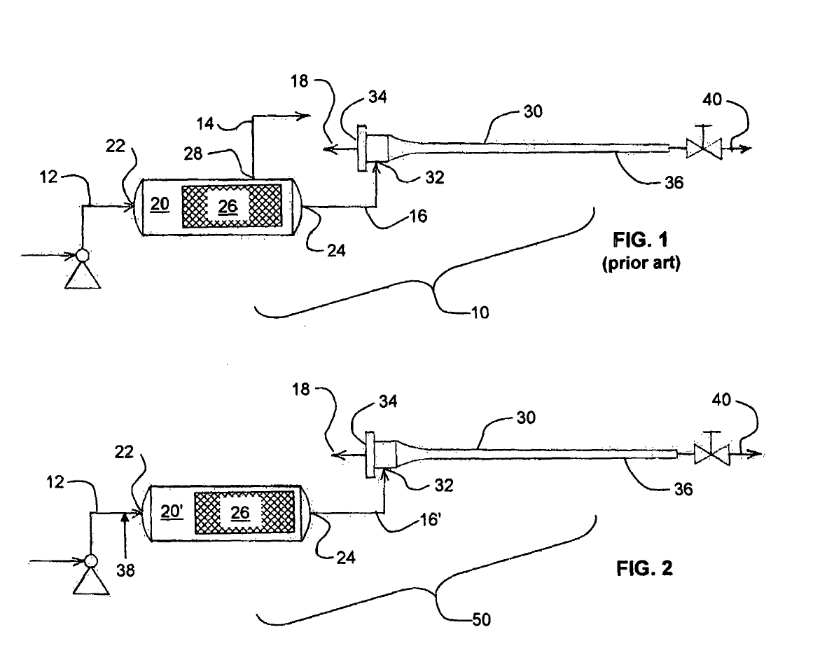

Shown in more detail with respect to FIG. 2 (having like reference numerals for like components of FIG. 1 previously discussed) is an exemplary system or apparatus 50 for separating a dispersed liquid phase (e.g. oil or hydrocarbon or non-aqueous phase) combined with a continuous liquid phase (e.g. an aqueous phase or water) in a fluid mixture, where the apparatus includes a vessel or coalescer or other container or enclosure, at least one first coalescer or first elongate hollow member 20′ and at least one separator hydrocyclone or second elongate hollow member 30. In one non-limiting embodiment herein, the second elongate hollow member 30 has a generally tapered profiles as seen in FIGS. 1 and 2, and/or conical profiles. Coalescer/vessel 20′ has an inlet 22 for accepting the fluid mixture (e.g. produced water) 12 into coalescer 20′.

In the known operation of coalescers, the produced water fluid mixture 20′ introduced through first inlet portion 22 of coalescer 20′ encounters coalescing media 26 (described in more detail above) that at least partially coalesces the dispersed liquid phase (e.g., contaminant droplets, oil, etc.).

As illustrated, coalescer 20′ does not include an oil overflow outlet or port 28 to permit the egress of oil 14 that is typically be found in a coalescer 20 of FIG. 1, but coalescer 20′ does include at least one outlet or first outlet portion 24 at the other end (or different place from inlet 22) thereof. Outlet 24 downstream of coalescing media 26 discharges a fluid mixture 16′ containing at least partially coalesced dispersed liquid phase. It will be appreciated that there is no particular threshold or level of coalescence that may or could be specified in advance for fluid mixture 16′, and that any degree or level of coalescence that improves the overall separation efficiency of the apparatus 50 over that of apparatus 10 is sufficient for the method and apparatus herein to be considered successful. That is, the method and apparatus herein should increase the separation efficiency as compared with a method and apparatus using only an otherwise identical coalescer and hydrocyclone, where the coalescer has an overflow oil outlet or port 28. Understood another way, first outlet portion 24 is configured to effuse all fluid flow egressing from the first vessel or coalescer 20′ and received at the second inlet portion 32. It should be understood that the average droplet or particle size of the dispersed phase in mixture 16′ should be greater than that of the droplets or particles in initial produced water 12. In one non-limiting embodiment, the initial droplet size in produced water 12 may be on the order of 15 μm, where the droplet size in mixture or fluid 16′ is much greater than this.

It will also be appreciated that in another non-restrictive version of the invention the first vessel or coalescer 20′ may be backwashable, that is, may be designed to periodically have a fluid flowed, channeled or pumped therethrough in a direction opposite to that shown in FIG. 2 to clean, unplug, and otherwise clear out the coalescing media 26 on a regular schedule or on an as-needed basis. It may be helpful in some non-limiting embodiments for the fluid used for the backwash to be a separate cleaning fluid of a suitable type, such as relatively pure water in one non-restrictive version.

At least partially coalesced fluid mixture 16′ passes to separator hydrocyclone or second elongate hollow member 30 via a second inlet portion 32 at the larger (left) end of the hydrocyclone 30. In the known operation of hydrocyclones, the introduction of fluid mixture 16′ into second inlet portion 32 generates a swirling motion or vortex in the chamber, interior or enclosure that largely or at least partially separates the dispersed liquid phase (e.g., contaminant droplets, oil, etc.) from the continuous phase (e.g. water). In one non-restrictive embodiment of the method, the vortex is generated along the inner, interior or inside wall of the first hollow member or vortex 30. In one non-limiting embodiment the first inlet portion 32 has a greater cross-section diameter, taken transverse to a longitudinal axis of the hydrocyclone or elongate member 30, than the third underflow outlet portion 36.

Separator hydrocyclone 30 substantially separates the at least partially coalesced liquid phase, e.g., oily contaminants, from the continuous phase, e.g., water. By “substantially separate” herein is meant that at least a majority (greater than 50 volume %) of the coalesced liquid phase, which is larger than certain size (cut size) is separated, alternatively at least 80 vol. % of the coalesced liquid phase is separated, and in another non-limiting embodiment, at least 90 vol. % of the coalesced liquid phase present is separated. The cut size refers to a specific contaminant size from the size distribution of dispersed phase, which is substantially separated in accordance with operational and geometrical parameters of the hydrocyclone.

Separator hydrocyclone 30 also includes at least one overflow outlet or second overflow outlet portion 34 for discharging a relatively less dense coalesced liquid phase 18. Overflow outlet 34 may be coaxial with a vortex finder (not shown) in hydrocyclone 30 on the axis of separator hydrocyclone 30 typically found in a hydrocyclone, as is known in the art. In one non-limiting embodiment, the second inlet portion 32 has a greater cross-section diameter, taken transverse to a longitudinal axis (not shown) of the second elongate member or hydrocyclone 30, than the second outlet portion 34.

Separator hydrocyclone 30 further includes at least one underflow outlet or third outlet portion 38 on the other end of the second separation chamber 30 from the at least one overflow outlet 34 for discharging a relatively more dense liquid phase 40 (e.g., clarified water) of the fluid mixture. In another non-restrictive version, second inlet portion 32 is physically intermediate the second and third outlet portions, 34 and 36, respectively. Further in another non-limiting embodiment, second outlet portion 34 of the second elongate hollow member 30 is located toward one side of the inlet portion 32 of the second elongate hollow member 30. Third outlet portion 36 of the second elongate hollow member 30 may be located on an opposite side from the second inlet portion 32 of the second elongate hollow member 30 and the second outlet portion 34 of the second elongate hollow member 30.

This apparatus or system has at least one fluid communication, such as a pipe, tube, conduit or other pathway between the at least one outlet 24 of the coalescer 20 and the at least one second inlet 32 of the at least one separator hydrocyclone 30. In the non-limiting embodiment of FIG. 2, this fluid communication pathway is tubing, a pipe or other conduit; however, other, alternate configurations may be usefully employed.

It will be understood that the vortex within the hydrocyclone 30 generates a G-force. In one non-limiting embodiment, the G-force may be in the order of tens or even hundreds of Gs. The G is defined herein as a unit measuring the inertial stress on a body undergoing rapid acceleration, expressed in multiples of the acceleration of one earth gravity.

In one optional embodiment, a chemical coalescing agent or demulsifier 38 may be introduced into the produced water 12 and/or or at least partially coalesced fluid mixture 16 through an opening, aperture, or other port (not shown) in the pipe, tubing or conduit through which these liquids pass. In one non-limiting embodiment, the chemical coalescing agent 38 is introduced upstream of first inlet 22, but may be introduced at other locations in addition to or alternative to this one. The optional chemical coalescing agent 38 aids in coalescing the particles or droplets of the dispersed phase (e.g., contaminant oil) together to form relatively larger particles or droplets. In one non-limiting embodiment such chemical coalescing agents or demulsifiers are polymers and are known in the art and may be used in dosages or amounts of about a few parts per million, based on the fluid or mixture treated. In other non-restrictive versions, if the produced water 12 contains solids, it may be necessary or helpful to pre-treat the water with a chemical coalescing agent or demulsifier of some type.

In the foregoing specification, the invention has been described with reference to specific embodiments thereof, and is expected to be effective in providing methods and apparatus for separating mixed liquid phases more efficiently. However, it will be evident that various modifications and changes can be made thereto without departing from the broader spirit or scope of the invention as set forth in the appended claims. Accordingly, the specification is to be regarded in an illustrative rather than a restrictive sense. For example, the coalescers and separators may be changed or optimized from that illustrated and described, and even though they were not specifically identified or tried in a particular apparatus, would be anticipated to be within the scope of this invention. For instance, the use of more coalescers and/or hydrocyclones in series would be expected to find utility and be encompassed by the appended claims. Different dispersed and continuous liquid phases, and different oily matter other than those described herein may nevertheless be treated and handled in other non-restrictive embodiments of the invention.

We claim:

1. An apparatus for separating a dispersed liquid phase from a continuous liquid phase within a fluid mixture, comprising:
a vessel having a first inlet portion and a first outlet portion and coalescing media intermediate the first inlet portion and the first outlet portion, wherein the first outlet portion is configured to effuse substantially all fluid flow received at the first inlet portion and egressing from the vessel;
an elongate hollow member having a second inlet portion, a second outlet portion, and a third outlet portion, the second inlet portion having a greater cross-section diameter, taken transverse to a longitudinal axis of the second elongate member, than the second outlet portion;
wherein the first outlet portion is in fluid communication with the second inlet portion; and
wherein the second inlet portion is upstream of the second and third outlet portions.

2. The apparatus as recited in claim 1, wherein the second inlet portion is physically intermediate the second and third outlet portions.

3. The apparatus of claim 1, wherein the elongate hollow member has a generally tapered profile.

4. The apparatus of claim 1, wherein the vessel lacks an overflow outlet.

5. An apparatus for separating a dispersed liquid phase from a continuous liquid phase within a fluid mixture, comprising:
at least one coalescer including:
a first separation chamber having a first inlet;
coalescing media downstream of the first inlet;
at least one outlet downstream of the coalescing media for discharging from the coalescer the fluid mixture comprising an at least partially coalesced dispersed liquid phase; and
at least one separator hydrocyclone including:
at least one second inlet for introducing the fluid mixture comprising the at least partially coalesced dispersed liquid phase into the hydrocyclone;
at least one overflow outlet for discharging therefrom a relatively less dense, coalesced liquid phase of the fluid mixture; and
at least one underflow outlet on the other end of the hydrocyclone from the at least one overflow outlet for discharging a relatively more dense liquid phase of the fluid mixture; and
at least one fluid communication between the at least one outlet of the at least one coalescer and the at least one second inlet of the at least one separator hydrocyclone.

6. The apparatus of claim 5 where the coalescer lacks an overflow outlet.

7. The apparatus of claim 5 where the at least one coalescer and at least one second separator hydrocyclone are within a single vessel.

8. The apparatus of claim 5 where the at least one coalescer is within a first vessel and the at least one separator hydrocyclone is within a second vessel.

9. The apparatus of claim 5 further comprising a port for introducing a chemical coalescing agent into the fluid mixture.

10. The apparatus of claim 9 where the port is upstream of the at least one first inlet.

11. A method for separating a dispersed liquid phase from a continuous liquid phase within a fluid mixture, comprising:
routing a flow of the fluid mixture comprising a dispersed liquid phase within a continuous liquid phase into a first inlet portion of a vessel;
at least partially coalescing the dispersed liquid phase by contacting it with coalescing media within the vessel;
egressing the flow of the fluid mixture only from a first outlet portion of the vessel;
routing the flow of the fluid mixture from the first outlet portion of the vessel to a second inlet portion of an elongate hollow member;
discharging a relatively less dense, at least partially coalesced liquid phase of the flow of fluid through a second outlet portion of the elongate hollow member; and
discharging a relatively more dense liquid phase of the flow of fluid through a third outlet portion of the elongate hollow member.

12. The method of claim 1 1 where the fluid mixture is a wellbore fluid.

13. The method of claim 1 1 where the vessel lacks an overflow outlet.

14. A method for separating a dispersed liquid phase from a continuous liquid phase within a fluid mixture, comprising:
introducing the fluid mixture into at least one coalescer;
contacting the fluid mixture within the coalescer with coalescing media to at least partially coalesce the dispersed liquid phase;
discharging the fluid mixture comprising the at least partially coalesced dispersed liquid phase to at least one separator hydrocyclone;
swirling the fluid mixture within the separator hydrocyclone to substantially separate and further coalesce the at least partially coalesced dispersed liquid phase;
discharging a relatively less dense, coalesced liquid phase of the fluid mixture through an overflow outlet of the separator hydrocyclone; and
discharging a relatively more dense liquid phase of the fluid mixture through an underflow outlet of the separator hydrocyclone.

15. The method of claim 14 where the coalescer lacks an overflow outlet.

16. The method of claim 14 where the at least one coalescer and the at least one separator hydrocyclone are within a single vessel.

17. The method of claim 14 where the at least one coalescer is within a first vessel and the at least one separator hydrocyclone is within a second vessel.

18. The method of claim 14 further comprising introducing a chemical coalescing agent into the fluid mixture.

19. The method of claim 18 where the chemical coalescing agent is injected into the fluid mixture upstream of the coalescer.

20. The method of claim 14 where the fluid mixture is a wellbore fluid.
